(19) United States
(12) Patent Application Publication
(10) Pub. No.: US 2021/0200996 A1
(43) Pub. Date: Jul. 1, 2021

(54) ACTION RECOGNITION METHODS AND APPARATUSES, ELECTRONIC DEVICES, AND STORAGE MEDIA

(71) Applicant: Beijing Sensetime Technology Development Co., Ltd., Beijing (CN)

(72) Inventors: Yanjie CHEN, Beijing (CN); Fei WANG, Beijing (CN); Chen QIAN, Beijing (CN)

(21) Appl. No.: 17/203,170

(22) Filed: Mar. 16, 2021

Related U.S. Application Data
(63) Continuation of application No. PCT/CN2020/081689, filed on Mar. 27, 2020.

(30) Foreign Application Priority Data
Mar. 29, 2019 (CN) 201910252534.6

(51) Int. Cl. G06K 9/00; G06K 9/62; G06K 9/20; G06K 9/32

(52) U.S. Cl. CPC G06K 9/00281; G06K 9/6256; G06K 9/3208; G06K 9/2054; G06K 9/3233; G06K 9/00335

(57) ABSTRACT

Action recognition methods and apparatuses, electronic devices, and storage media are provided. The method includes: obtaining mouth key points of a face based on a face image; determining, based on the mouth key points, an image in a first region involving at least part of the mouth key points and comprising an image of an object interacting with a mouth; and determining whether a person corresponding to the face image is smoking based on the image in the first region.

### CROSS REFERENCE TO RELATED APPLICATIONS

This patent application is a continuation application of International Application No. PCT/CN2020/081689, filed on Mar. 27, 2020, which is based on and claims priority to and benefits of Chinese Patent Application No. 201910252534.6 entitled “ACTION RECOGNITION METHODS AND APPARATUSES, ELECTRONIC DEVICES AND STORAGE MEDIA,” filed on Mar. 29, 2019. The entire content of all of the above applications is incorporated herein by reference.

### TECHNICAL FIELD

The present disclosure relates to the field of computer vision technologies, and in particular, to action recognition methods and apparatuses, electronic devices, and storage media.

### BACKGROUND

In the field of computer vision, the action recognition is always an issue of great interest. In general, researches on action recognition focus on a temporal sequential feature of a video, and some actions that may be recognized in accordance with body key points.

### SUMMARY

The embodiment of the present disclosure provides an action recognition technology.

According to an aspect of the embodiments of the present disclosure, an action recognition method is provided, including: obtaining mouth key points of a face based on a face image; determining, based on the mouth key points, an image in a first region involving at least part of the mouth key points and comprising an image of an object interacting with mouth; and determining whether a person corresponding to the face image is smoking based on the image in the first region.

According to another aspect of the embodiments of the present disclosure, an action recognition device is provided, including: a mouth key point module, configured to obtain mouth key points of a face based on a face image; a first region determining module, configured to determine, based on the mouth key points, an image in a first region involving at least part of the mouth key points and comprising an image of an object interacting with mouth; and a smoking recognizing module, configured to determine whether a person corresponding to the face image is smoking based on the image in the first region.

According to another aspect of the embodiments of the present disclosure, an electronic device is provided, including a processor, wherein the processor includes an action recognition apparatus according to any of the foregoing embodiments.

According to still another aspect of the embodiments of the present disclosure, an electronic device is provided, including: a memory for storing executable instructions; and a processor, configured to communicate with the memory to execute the executable instructions to perform operations in the action recognition method in any of the above embodiments.

According to another aspect of the embodiments of the present disclosure, a computer readable storage medium is provided for storing computer readable instructions, wherein the instructions are executed to perform the operations in the action recognition method according to any of the above embodiments.

According to another aspect of the embodiments of the present disclosure, a computer program product is provided, which includes computer readable codes, wherein the computer readable codes are running on a device to cause a processor in the device to execute instructions for implementing the action recognition method according to any of the above embodiments.

Based on the action recognition methods and apparatuses, electronic devices, and storage media according to the above embodiments of the disclosure, mouth key points of a face is obtained based on a face image; an image in a first region is determined based on the mouth key points, and the image in the first region includes at least part of mouth key points and an image of an object interacting with mouth; and based on the image in the first region, it may determine whether the person corresponding to the face image is smoking. By recognizing the image in the first region determined with the mouth key points and accordingly determining whether the person corresponding to the face image is smoking, the recognition range is effectively reduced and attention may be focused on the mouth and the object interacting with mouth, thereby improving the detection rate, reducing the false detection rate, and improving the accuracy of smoking recognition.

The technical solution of the present disclosure will be further described in detail below through the drawings and embodiments.

### BRIEF DESCRIPTION OF THE DRAWINGS

The accompanying drawings, which form a portion of the description, describe embodiments of the present disclosure, and together with the description serve to explain the principles of the present disclosure.

The present disclosure will be more clearly understood from the following detailed description with reference to the accompanying drawings.

FIG. 1 is a schematic flowchart of an action recognition method according to an embodiment of the present disclosure.

FIG. 2 is another schematic flowchart of an action recognition method according to an embodiment of the present disclosure.

FIG. 3A is a schematic diagram of a first key point obtained via recognition in an action recognition method according to an embodiment of the present disclosure.

FIG. 3B is a schematic diagram of a first key point obtained via recognition in an action recognition method according to another embodiment of the present disclosure.

FIG. 4 is another schematic flowchart of an action recognition method according to an embodiment of the present disclosure.

FIG. 5 is a schematic diagram illustrating an alignment operation performed on an object interacting with mouth in an action recognition method according to another embodiment of the present disclosure.

FIG. 6A illustrates a captured original image in an action recognition method according to an embodiment of the present disclosure.

FIG. 6B is a schematic diagram of detecting a face frame in an action recognition method according to an embodiment of the present disclosure.

FIG. 6C is a schematic diagram of a first region determined based on key points in an action recognition method according to an embodiment of the present disclosure.

FIG. 7 is a schematic structural diagram of the action recognition apparatus according to an embodiment of the present disclosure.

FIG. 8 is a schematic structural diagram of an electronic device applicable to a terminal device or a server according to an embodiment of the present disclosure.

### DETAILED DESCRIPTION OF THE EMBODIMENTS

Various exemplary embodiments of the present disclosure will now be described in detail with reference to the accompanying drawings. It should be noted that the relative arrangements, numerical expressions, and numerical values of the components and steps set forth in these embodiments do not limit the scope of the present disclosure unless specifically stated otherwise.

For convenience of description, the dimensions of the various portions shown in the figures are not drawn according to actual proportional relationships.

The following description of at least one exemplary embodiment is practically merely illustrative, in no way limiting of the present disclosure and its application or use.

Techniques, methods, and apparatuses known to those of ordinary skill in the relevant art may not be discussed in detail, but the techniques, methods, and apparatuses should be considered as portion of the description unless otherwise specified.

It should be noted that like reference signs and letters denote like items in the following drawings, and therefore, once a certain item is defined in one figure, no further discussion thereof is needed in the following drawings.

Embodiments of the present disclosure may be applicable to computer systems/servers, which may operate with numerous other general purpose or special purpose computing system environments or configurations. Examples of well-known computing systems, environments and/or configurations suitable for use with computer systems/servers include, but are not limited to, personal computer systems, server computer systems, thin clients, thick clients, hand-held or laptop devices, microprocessor-based systems, set-top boxes, programmable consumer electronics, network personal computers, minicomputer systems, mainframe computer systems, and distributed cloud computing technology environments including any of the above, and the like.

The computer system/server may be described in the general context of computer system-executable instructions, such as program modules, executed by the computer system. In general, program modules may include routines, programs, target programs, components, logic, data structures, etc. that perform particular tasks or implement particular abstract data types. The computer system/server may be implemented in a distributed cloud computing environment in which tasks are performed by a remote processing device linked via a communication network. In a distributed cloud computing environment, the program modules may be located on a local or remote computing system storage medium including a storage device.

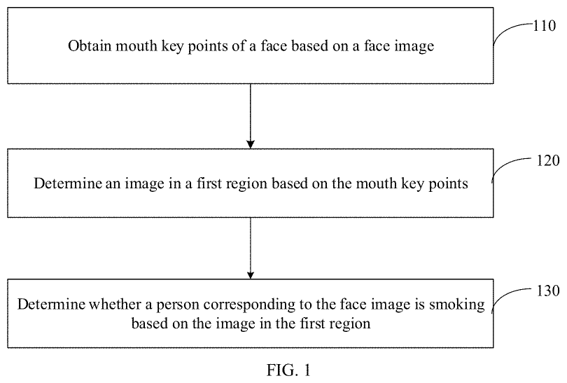

FIG. 1 is a schematic flowchart of an action recognition method according to an embodiment of the present disclosure. The method may be applicable to an electronic device, as shown in FIG. 1, the method of this embodiment includes the following steps.

At step 110, mouth key points of a face are obtained based on a face image.

The mouth key points in the embodiment of the present disclosure may be performed by labelling the mouth on the face. The mouth key points may be obtained by any implementable face key point recognition method in the prior art. For example, some face key points on the face are recognized by using a deep neural network, the mouth key points then are obtained by separating from the face key points. For another example, the mouth key points are recognized directly by using deep neural network. The embodiment of the present disclosure does not limit the specific manner of obtaining a mouth key point.

In an example, the step 110 may be performed by the processor invoking corresponding instructions stored in the memory, or by the mouth key point module 71 executed by the processor.

At step 120, an image in a first region is determined based on the mouth key points.

In an example, the image in the first region involves at least part of the mouth key points and comprises an image of an object interacting with the mouth. The action recognition in the embodiment of the present disclosure is mainly used for recognizing whether a person corresponding to an image is smoking, and since the smoking action is realized by contacting the mouth with the cigarette, not only part (a portion) or all of the mouth key points are included in the first region, but also an object interacting with mouth may be included. When the object interacting with mouth is the cigarette, it is determined that the person corresponding to the image may smoke. As an example, the first region in the embodiment of the present disclosure may be of any shape such as a rectangle or a circle determined based on the center of the mouth. In the embodiment of the present disclosure, the shape and size of the image in the first region are not limited, taking an interaction such as cigarette and rod sugar that may be in contact with the mouth in the first region as a standard.

In an example, step 120 may be performed by the processor invoking the corresponding instructions stored in the memory, or by the first region determining module 72 executed by the processor.

At step 130, it is determined whether a person corresponding to the face image is smoking based on the image in the first region.

In the embodiment of the present disclosure, it is determined whether the person corresponding to the face image is smoking by recognizing whether the object interacting with mouth included in a region in the vicinity of the mouth is cigarette, centralizes a point of interest in the vicinity of the mouth, which reduces the probability that other irrelevant images interfere with the recognition result, and improves the accuracy of recognizing smoking action.

In an example, the step 130 may be performed by the processor invoking the corresponding instructions stored in the memory, or by the smoking recognizing module 73 executed by the processor.

Based on the action recognition method according to the above embodiments of the present disclosure, the mouth key points of the face is obtained based on the face image; and the image in the first region is determined based on the mouth key points, and the image in the first region includes at least part of mouth key points and an object interacting with mouth. Based on the image in the first region, it is determined whether the person corresponding to the face image is smoking, and the image in the first region determined by the mouth key points is identified to determine whether the person corresponding to the face image is smoking, which reduces the recognition range, concentrates attention on the mouth and the object interacting with mouth, thereby improving the detection rate, reducing the false detection rate, and improving the accuracy of smoking recognition.

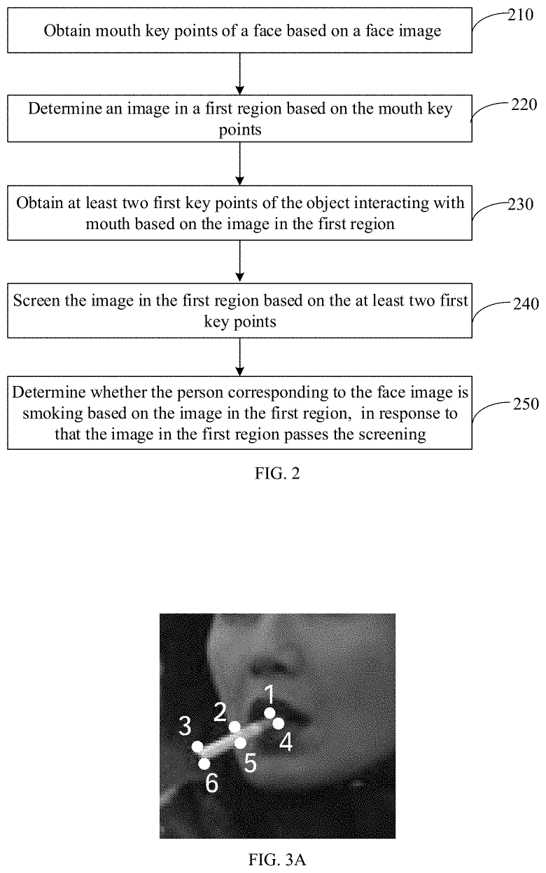

FIG. 2 is another schematic flowchart of an action recognition method according to an embodiment of the present disclosure. As shown in FIG. 1, the method in this embodiment includes the following steps.

At step 210, mouth key points of a face are obtained based on a face image.

At step 220, an image in a first region is determined based on the mouth key points.

At step 230, at least two first key points of the object interacting with mouth are obtained based on the image in the first region.

In an example, key point extraction on the image in the first region may be performed via a neural network, so as to obtain at least two first key points of the object interacting with mouth, and the first key points may appear as a straight line in the first region (for example, extracting cigarette key points from an axis in the cigarette) or two straight lines (for example, extracting cigarette key points from two sides of the cigarette), etc.

At step 240, the image in the first region is screened based on the at least two first key points.

The screening operation is to select out the image in the first region in which the object interacting with mouth and having a length greater than or equal to a preset value is involved.

In an example, the length of the object interacting with mouth in the first region may be determined by at least two first key points on the obtained object that interacts with the mouth. When the length of the object interacting with mouth is small (for example, the length of the object interacting with mouth is less than a preset value), the object interacting with mouth included in the first region is not necessarily a cigarette. In this case, it may be determined that the image in the first region does not include a cigarette. Only when the length of the object interacting with mouth is large (for example, the length of the object interacting with mouth is greater than or equal to a preset value), it is determined that a cigarette may be included in the image in the first region.

At step 250, in response to that the image in the first region passes the screening, it is determined whether the person corresponding to the face image is smoking based on the image in the first region.

In the embodiment of the present disclosure, the above screening operation determines an image in part of the first region, and the image in the portion of the first region includes an object interacting with mouth and has a length reaching a preset value. Only when the length of the object interacting with mouth reaches a preset value, It is determined that the object interacting with mouth may be a cigarette. In this step, it is determined whether the person in the face image is smoking with respect to the image in the first region which passes the screening. In other words, when an object interacting with mouth has a length greater than the preset value, it is determined whether the object interacting with mouth is a cigarette to determine whether the person in the face image is smoking.

In an example, step 240 includes:

key point coordinates corresponding to at least two first key points in the image in the first region are determined based on the at least two first key points; and

the image in the first region is screened based on the key point coordinates corresponding to the at least two first key points.

After the at least two first key points of the object interacting with mouth are obtained, it is not possible to completely determine whether the person in the face image is smoking, maybe other similar objects (e.g., rod sugar or other elongated objects, etc.) are contained in the mouth. The cigarette generally has a certain length to determine whether the first region includes the cigarette. In the embodiment of the present disclosure, the key point coordinates of the first key point are determined, and the length of the object interacting with mouth in the first region image is determined based on the key point coordinates of the first key point in the first region, thereby determining whether the person in the face image is smoking.

In an example, the image in the first region is screened based on the key point coordinates corresponding to the at least two first key points includes:

a length of the object interacting with mouth in the image in the first region is determined based on the key point coordinates; and

in response to the length of the object interacting with mouth being greater than or equal to the preset value, it is determined that the image in the first region passes the screening.

In an example, in order to determine the length of the object interacting with mouth, after the key point coordinates of the at least two first key points are obtained, the at least two first key points at least include a key point on an end of the object near the mouth and a key point on another end of the object away from the mouth. For example, the key points near the mouth are defined as p1 and p2 respectively, and the key points away from the mouth are defined as p3 and p4 respectively. It is assumed that the midpoint between p1 and p2 is p5 and the midpoint between p3 and p4 is p6. In this case, the coordinates of p5 and p6 may be used to determine the length of the cigarette.

In an example, in response to the length of the object interacting with mouth being less than the preset value, it is determined that the image in the first region fails to pass the screening. Then, It may be determined that a cigarette is not involved in the image in the first region.

Since a large difficulty in the detection of smoking action is how to differentiate a small portion of the cigarette on the image (i.e., when the cigarette substantially exposes only one cross section) and the driver is not in the state of smoking, the feature extracted by the neural network needs to capture very slight detail of the mouth in the image. When the network is required to detect sensitively an object with only exposing a cross section in an image, the false detection rate of the algorithm will be increased. Therefore, in the embodiment of the present disclosure, based on the first key point of the object interacting with mouth, the image in which the portion of the object interacting with mouth is slightly exposed or nothing in the driver's mouth is directly filtered, before sending to the classification network. By testing the trained network, it is found that in the key point detection algorithm, after the deep network uses the gradient backpropagation algorithm to update the network parameters, it will focus on the edge information of the object interacting with mouth in the image. When some people do not smoke and no strips are around the mouth that will interfere, the prediction of key points will tend to be distributed in an average position in the center of the mouth (even if there is no cigarette at this time). According to the above characteristics, the first key point is used to filter the image that only a small portion of the object interacting with mouth is exposed or that there is nothing on the driver's mouth (that is, the object interacting with mouth only shows a small portion, approximately showing only a cross section of the object, the smoking judgment on the image is insufficient, and it is considered that cigarettes are not involved in the first region).

In an example, step 240 further includes:

A serial number is assigned to each of the at least two first key points for distinguishing each first key point.

By assigning different serial numbers to the first key points, each first key point may be distinguished, and different purposes are achieved by different first key points. For example, the length of the current object may be determined by a first key point closest to the mouth and another first key point farthest from the mouth. The embodiments of the present disclosure may assign serial numbers to the first key points according to an arbitrary non-repetitive order to distinguish different first key points. The embodiments of the present disclosure do not limit the manner of assigning serial numbers, for example, each serial number is assigned to each first key point according to an order of a fork multiplication rule.

In one or more embodiments, based on the at least two first key points, key point coordinates corresponding to the at least two first key points are determined in the image in the first region, includes:

key point coordinates corresponding to the at least two first key points are determined in the image in the first region by using a first neural network.

The first neural network is trained with a first sample image.

In an example, the first sample image comprises labelled key point coordinates.

The process of training the first neural network comprises:

the first sample image is input into the first neural network to obtain predicted key point coordinates corresponding to the at least two first key points; and

a first network loss is determined based on the predicted key point coordinates and the labelled key point coordinates, and a parameter of the first neural network is adjusted based on the first network loss.

In an example, a first key point positioning task, similar to a face key point positioning task, may be regarded as a regression task, so as to obtain a mapping function of the two-dimensional coordinates (xᵢ, yᵢ) of the first key point, and the algorithm is described as follows.

The input of layer 1 of the first neural network is denoted as xᵢ (i.e., an input image), the output of an intermediate layer of the first neural network is xₙ, and each layer of network is equivalent to an nonlinear mapping F(x). Assuming that the first neural network has a total of N layers, then after passing through the nonlinear mapping of the first neural network, the output of the first neural network may be abstracted as the expression of formula 1:

ŷ=F^{N}(x) formula 1

where ŷ is a one-dimensional vector output by the first neural network, and each value in the one-dimensional vector represents a key point coordinate finally output by the network.

In one or more embodiments, step 230 includes:

key points of objects that interacts with the mouth are identified for the images in the first region, and the at least two central axis key points on a central axis of the object interacting with mouth, and/or at least two side key points on each of the two sides of the objects that interacts with the mouth.

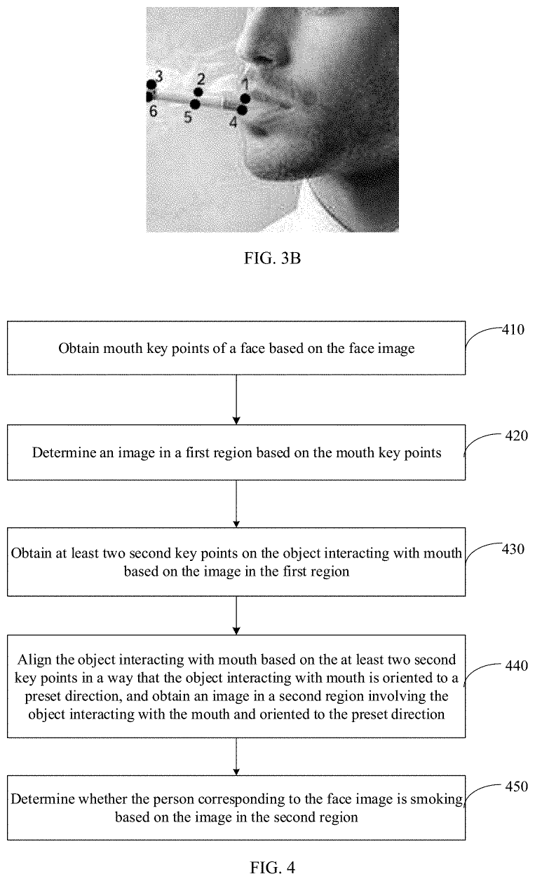

In the embodiment of the present disclosure, when the first key point is defined, the central axis key points on the central axis of the object interacting with mouth in the image may be used as the first key points, and/or the side key points on each of the two sides of the object interacting with mouth in the image may be used as the first key points. In order to perform subsequent key point alignment, the key points on each of the two sides is taken as an example. FIG. 3A is a schematic diagram of a first key point obtained via recognition in action recognition method according to an embodiment of the present disclosure. FIG. 3B is a schematic diagram of a first key point obtained via recognition in an action recognition method according to an embodiment of the present disclosure. As shown in FIG. 3A and FIG. 3B, the key points on each of the two sides are defined as a first key points, and in order to identify different first key points and obtain key point coordinates corresponding to different first key points, different serial numbers may be assigned to each of the first key points.

FIG. 4 is another schematic flowchart of an action recognition method according to an embodiment of the present disclosure. As shown in FIG. 4, the method in this embodiment includes the following steps.

At step 410, mouth key points of a face are obtained based on the face image.

At step 420, an image in a first region is determined based on the mouth key points.

At step 430, at least two second key points on the object interacting with mouth are obtained based on the image in the first region.

In an example, the at least second key points obtained in this embodiment and the first key points in the above embodiment are both key points on an object interacting with mouth, and the second key points may be the same as or different from the first key points.

At step 440, the object interacting with mouth is aligned based on the at least two second key points in a way that the object interacting with mouth is oriented to a preset direction, and an image in a second region involving the object interacting with mouth and oriented to the preset direction is obtained.

The image in the second region involves at least part of the mouth key points and comprises an image of an object interacting with the mouth.

In the embodiment of the present disclosure, the object interacting with mouth is aligned by obtaining the second key points. so that the object interacting with mouth is oriented to a preset direction; and an image in a second region of the object interacting with mouth and is oriented to the preset direction is obtained, the second region and the first region in the above embodiments may have overlapping portions, for example, the second region involves at least part of the mouth key points in the image of the first region and includes the image of the object interacting with mouth. The action recognition method according to the embodiment of the present disclosure may include a plurality of implementations, for example, if only the screening operation is performed on the image in the first region, the first key point of the object interacting with mouth needs to be determined, and the object interacting with mouth is aligned based on the at least two second key points. If the alignment operation is performed on only the object interacting with mouth, the second key point of the object interacting with mouth needs to be determined, and the alignment operation is performed on the object interacting with mouth based on at least two second key points. If both the screening operation and the alignment operation are performed, the first key points and the second key points of the object interacting with mouth need to be determined, where the first key points may be the same as or different from the second key points, and the second key points and the coordinates thereof may be determined by referring to the first key points and the coordinates thereof, and the operation sequence of the screening operation and the alignment operation is not limited in the embodiment of the present disclosure.

In an example, step 440 may include that, corresponding key point coordinates are obtained based on at least two second key points, and an alignment operation is performed based on the obtained key point coordinates corresponding to the second key points. The process of obtaining the key point coordinates based on the second key points may be, similar to the process of obtaining the key point coordinates based on the first key points, for example, obtained by the neural network, the embodiment of the present disclosure does not limit the specific manner including the alignment operation based on the second key points.

In an example, step 440 may further include that, a serial number for distinguishing each second key point is assigned to each of the at least two second key points. The rule of assigning the serial number may refer to the manner of assigning the serial number to the first key point, which is not described herein.

At step 450, it is determined whether the person corresponding to the face image is smoking based on the image in the second region.

Due to the poor rotation invariance of convolutional neural networks, the feature extraction of the neural network at different degrees of rotation of the object has a certain difference. When a person is smoking, the direction of the cigarette may be in different directions, and if the feature extraction is performed directly on the original captured image, the detection performance of smoking or not may occur to a certain extent. In other words, the neural network needs to adapt to the feature extraction of cigarette at different angles, so as to perform a certain degree of decoupling. In the embodiment of the present disclosure, the alignment operation is performed based on the second key points, so that the objects that interacts with the mouth in each input face image are directed in the same direction, which can reduce the probability of false detection.

In an example, the alignment operation may include:

key point coordinates are obtained based on the at least two second key points, and the object interacting with mouth is obtained based on key point coordinates corresponding to the at least two second key points; and

an alignment operation on the object interacting with mouth is performed based on the preset direction by using affine transformation, so that the object interacting with mouth is oriented to the preset direction, and the image in the second region involving the object interacting with mouth and oriented to the preset direction is obtained.

The affine transformation may include, but is not limited to, at least one of the following: rotation, scaling, translation, flipping, shearing, etc.

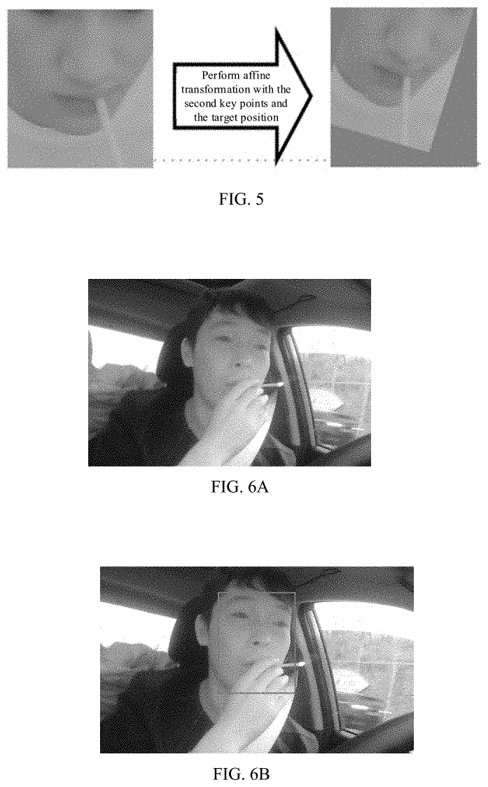

In the embodiment of the present disclosure, pixels in the image of the object interacting with mouth are mapped to a new image aligned by the key points via the affine transformation. The original second key points are aligned with the previously preset key points. In this way, the signal of the object interacting with mouth in the image and the angle information of the object interacting with mouth may be decoupled, thereby improving the feature extraction performance of the subsequent neural network. FIG. 5 is a schematic diagram of performing an alignment operation on an object interacting with mouth in an action recognition method according to another embodiment of the present disclosure. As shown in FIG. 5, the direction of the object interacting with mouth in the first region image is transformed by performing the affine transformation using the second key points and the target position, and in this example, the direction of the object (cigarette) that interacts with the mouth is turned downward.

The key point alignment is performed by the affine Transformation. The function of the affine transformation is a linear transformation from two-dimensional coordinates to two-dimensional coordinates, keeping ‘straightness’ and ‘parallelism’ of the two-dimensional graph. The affine transformation may be implemented by a combination of a series of atomic transformation, where the atomic transformation may include, but is not limited to, translation, scaling, flipping, rotation, shearing, etc.

The second coordinate system of the affine transformation is shown in formula (2):

$$[ \begin{matrix}{x}^{′} & {y}^{′} & 1\end{matrix} ] = \begin{matrix}[ x & y & 1 ]\end{matrix} \cdot [ \begin{matrix}{a}_{11} & {a}_{12} & 0 \\ {a}_{12} & {a}_{22} & 0 \\ {x}_{0} & {y}_{0} & 1\end{matrix} ] \qquad formula ( 2 )$$

where, [x′ y′ 1] represents the coordinates obtained after the affine transformation, [x y 1] represents the key point coordinates of the extracted cigarette key points,

$$[ \begin{matrix}{a}_{11} & & {a}_{12} \\ {a}_{12} & & {a}_{22}\end{matrix} ]$$

represents the rotation matrix, and, x₀ and y₀ represent the translation vectors.

The above expressions encompass several operations of rotation, translation, scaling, and rotation. Assuming that the key points given by the model are a set of (xᵢ, yᵢ), the preset target point position (xᵢ′, yᵢ′) (the target point position here may be preset by human implementation), the affine transformation matrix performs the affine transformation on the source image to the target image, and after capturing, the regular image is obtained.

In an example, step 130 includes:

it is determined whether the person corresponding to the face image is smoking based on the image in the first region by the second neural network.

The second neural network is trained with the second sample image. The second sample image comprises a sample image of smoking and a sample image of non-smoking, so that the neural network may be trained to distinguish cigarettes from other elongated objects, thereby identifying whether they are smoking or having something else in their mouth.

In the embodiment of the present disclosure, the obtained key point coordinates are input to the second neural network for classification (for example, a classification convolutional neural network). As an example, the operation process is also performed by the convolutional neural network for feature extraction, and the result of the binary (2-class) classification is finally output, that is, the probability that the image belongs to a smoking or non-smoking image is fitted.

In an example, the second sample image is associated with a label of whether the person corresponding to the image is smoking.

The process of training the second neural network comprises:

inputting the second sample image into the second neural network, to obtain a prediction of whether the person corresponding to the second sample image is smoking; and

obtaining a second network loss based on the prediction and the label, and adjusting a parameter of the second neural network based on the second network loss.

In an example, during the process of training the second neural network, the network supervision may adopt a softmax loss function, and the mathematical expression is as follows.

pᵢ represents the probability that the prediction of the i^{th} second sample image output by the second neural network is the actual correct category (i.e., label), and N represents the total number of samples.

The loss function may adopt the following formula (3):

$${L}_{softmax} = - \frac{1}{N} {\sum }_{i = 1}^{N} log ( {p}_{i} ) \qquad formula ( 3 )$$

After the network structure and the loss function are defined, training only needs to update the network parameters according to the calculation method of gradient back propagation, to obtain the network parameters of the second neural network after training.

After the second neural network is trained, the loss function is removed and the fixed network parameter is unchanged, and the pre-processed image is also input to the convolutional neural network to extract features and classifications, so that the classification result given by the classification module may be obtained. Thus, it is determined whether the person in the screen is smoking.

In one or more embodiments, step 110 includes:

face key point extraction is performed on a face image to obtain face key points in the face image; and

the mouth key points are obtained based on the face key points.

In an example, the face key point extraction is performed on the face image by the neural network, and since the smoking action and the interaction mode of the person are mainly performed with a mouth and a hand, the smoking action is basically in the vicinity of the mouth when the smoking action is performed, the valid information region (first region image) may be reduced to the vicinity of the mouth by the face detection and the face key point positioning technology. In an example, the extracted face key points are edited in serial numbers, and the mouth key points may be obtained by setting the key points of certain serial numbers as mouth key points or by obtaining the mouth key points from the positions of the face key points in the face image, and the first region image is determined based on the mouth key points.

In some examples, the face image of the embodiment of the present disclosure is obtained by the face detection. The captured image is subjected to the face detection to obtain a face image. The face detection is an underlying infrastructure module for whole smoking action recognition. Since a smoker has a face on the image when he is smoking, the position of the face can be roughly located by the face detection, and the embodiment of the present application does not limit the specific face detection algorithm.

After the face frame is obtained by the face detection, an image in the face frame (corresponding to the face image in the above embodiment) is captured and the face key points are extracted. In an example, the face key point positioning task may actually be abstracted as a regression task: given an image containing face information, a mapping function of the two-dimensional coordinates (xᵢ,yᵢ) of the key points in the image is fitted. For an input image, the detected face position is captured, and the fitting of the network is performed only within a range of one local image, thereby improving the fitting speed. Face key points mainly include key points of five senses. The embodiments of the present disclosure mainly focus on key points of mouth, for example, mouth corner points, lip contour key points, etc.

In an example, an image in a first region is determined based on the mouth key points includes:

a center of the mouth is determined based on the mouth key points; and

the first region is determined by taking the center of the mouth as a center point of the first region and taking a preset length as a side length or a radius.

In the embodiments of the present disclosure, in order to include the region where cigarettes may appear in the first region, the center of the mouth is determined as the center point of the first region of the image, and a first region of a rectangle or a circle is determined by using a preset length as a radius or a side length. As an example, the preset length may be preset in advance, or determined according to the distance between the center of the mouth and a certain key point in the face. For example, the preset length may be determined based on the distance between one of the mouth key points and the eyebrow key point.

In an example, the eyebrow key points are obtained based on face key points; and

the first region is determined by taking the center of the mouth as the center point of the first region, and taking a preset length as a side length or a radius, comprising:

the first region is determined by taking the center of the mouth as the center point and taking a vertical distance from the center of the mouth to a center of an eyebrow as a side length or a radius.

Where the center of the eyebrow is determined based on the at least one eyebrow key point.

For example, after positioning the face key points, the vertical distance d between the center of the mouth and the center of the eyebrow is calculated, then a square region R with the center of the mouth as the center of the square region and 2d as the side length is obtained, and the region R is taken as the first region of the embodiment of the present disclosure.

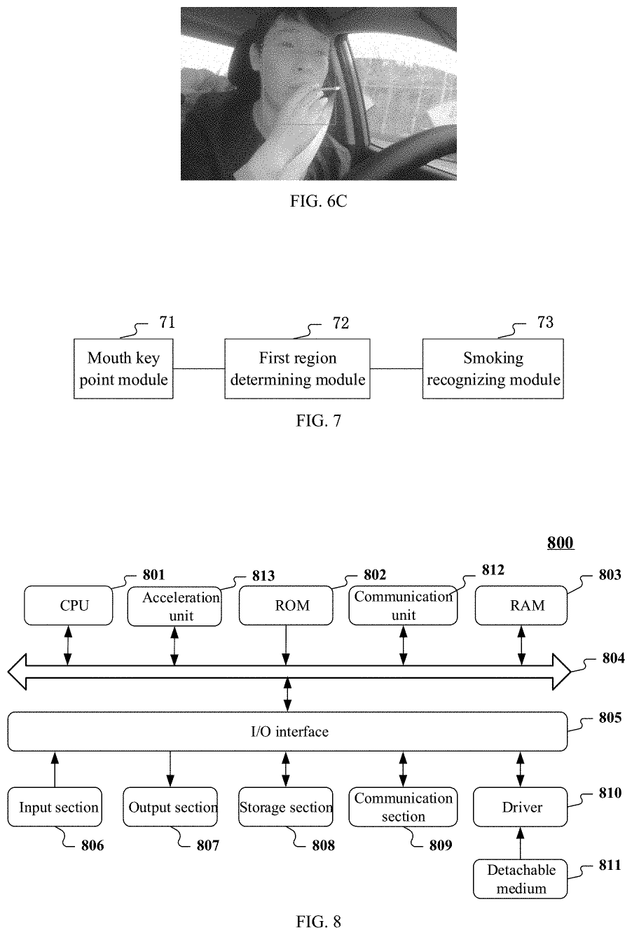

FIG. 6A is a captured original image of the action recognition method according to the embodiment of the present disclosure. FIG. 6B is a schematic diagram of detecting a face frame in an action recognition method according to an embodiment of the present disclosure. FIG. 6C is a schematic diagram of a first region determined based on key points in the action recognition method according to an embodiment of the present disclosure. In an example, referring to FIGS. 6A, 6B and 6C, the process of obtaining the first region based on the captured original image is implemented.

A person of ordinary skill in the art may understand that all or portion of the steps of the method embodiments may be implemented by hardware related to program instructions, and the program may be stored in a computer readable storage medium, and when the program is executed, the steps of the method embodiments are performed. The storage medium includes any medium that may store program codes, such as a ROM, a RAM, a magnetic disk, or an optical disk.

FIG. 7 is a schematic structural diagram of an action recognition apparatus according to an embodiment of the present disclosure. The apparatus in this embodiment may be configured to implement the foregoing method embodiments of the present disclosure. As shown in FIG. 7, the apparatus in this embodiment includes: a mouth key point module 71, a first region determining module 72 and a smoking recognizing module 73.

The mouth key point module 71 is configured to obtain mouth key points of a face based on a face image.

The first region determining module 72 is configured to determine an image in a first region based on the mouth key points.

The image in the first region involves at least part of the mouth key points and comprises an image of an object interacting with mouth.

The smoking recognizing module 73 is configured to determine whether a person corresponding to the face image is smoking based on the image in the first region.

Based on the action recognition apparatus according to the above embodiment of the present disclosure, mouth key points of a face is obtained based on a face image; an image in a first region is determined based on the mouth key points, the image in the first region includes at least part of the mouth key points and an object interacting with mouth; and based on the image in the first region, it is determined whether the person corresponding to the face image is smoking, and the first region determined by the mouth key point identifies whether the person is smoking, which reduces the recognition range, and concentrates attention on the mouth and the object interacting with mouth, thereby improving the detection rate, reducing the false detection rate, and improving the accuracy of smoking recognition.

In one or more embodiments, the apparatus further includes: a first key point module and an image filtering module.

The first key point module is configured to obtain at least two first key points on the object interacting with mouth based on the image in the first region.

The image filtering module, configured to screen the image in the first region based on the at least two first key points, to select out the image in the first region in which the object interacting with mouth and having a length greater than or equal to a preset value is involved.

The smoking recognizing module 73 is configured to determine whether the person corresponding to the face image is smoking based on the image in the first region, in response to that the image in the first region passes the screening.

In an example, the image filtering module is configured to, determine key point coordinates corresponding to the at least two first key points in the image in the first region based on the at least two first key points, and screen the image in the first region based on the key point coordinates.

In an example, the image filtering module is configured to, when screening the image in the first region based on the key point coordinates, determine a length of the object interacting with mouth in the image in the first region based on the key point coordinates; and in response to the length of the object interacting with mouth being greater than or equal to the preset value, determine that the image in the first region passes the screening.

In an example, the image filtering module is further configured to, when screening the image in the first region based on the key point coordinates, in response to the length of the object interacting with mouth being less than the preset value, determine that the image in the first region fails to pass the screening, and determine that the image in the first region does not involve a cigarette.

In an example, the image filtering module is further configured to assign a serial number to each of the at least two first key points to distinguish the at least two first key points.

In an example, the image filtering module is configured to, determine, by a first neural network, the key point coordinates corresponding to the at least two first key points in the image in the first region, wherein the first neural network is trained with a first sample image, when determining the key point coordinates corresponding to the at least two first key points in the image in the first region.

In an example, the first sample image includes labelled key point coordinates; and training the first neural network includes:

inputting the first sample image into the first neural network to obtain predicted key point coordinates corresponding to the at least two first key points; and

determining a first network loss based on the predicted key point coordinates and the labelled key point coordinates, and adjusting a parameter of the first neural network based on the first network loss.

In an example, the first key point module is configured to perform a key point recognition for the object interacting with mouth on the image in the first region, and obtain at least two central axis key points on a central axis of the object interacting with mouth, and/or at least two side key points on each of the two sides of the object interacting with mouth.

In one or more embodiments, the apparatus according to the embodiments of the present disclosure further includes a second key point module, and an image aligning module.

The second key point module is configured to obtain at least two second key points on the object interacting with mouth based on the image in the first region.

The image aligning module is configured to align the object interacting with mouth based on the at least two second key points in a way that the object interacting with mouth is oriented to a preset direction, obtain an image in a second region of the object interacting with mouth and oriented to the preset direction, wherein the image in the second region includes at least part of the mouth key points and the object interacting with mouth.

The smoking recognizing module 73 is configured to determine whether the person corresponding to the face image is smoking based on the image in the second region.

In one or more embodiments, the smoking recognizing module 73 is configured to determine, by a second neural network, whether the person corresponding to the face image is smoking based on the image in the first region, wherein the second neural network is trained with a second sample image.

In an example, the second sample image is associated with a label of whether the person corresponding to the image is smoking; and training the second neural network includes:

inputting the second sample image into the second neural network, to obtain a prediction of whether the person corresponding to the second sample image is smoking; and

obtaining a second network loss based on the prediction and the label, and adjusting a parameter of the second neural network based on the second network loss.

In one or more embodiments, the mouth key point module 71 is configured to perform face key point extraction on the face image to obtain a plurality of face key points in the face image; and obtain the mouth key points based on the plurality of face key points.

In an example, the first region determining module 72 is configured to determine a center of the mouth based on the mouth key points; and determine the first region by taking the center of the mouth as a center point of the first region and taking a preset length as a side length or a radius.

In an example, the apparatus according to the embodiment of the present disclosure further includes an eyebrow key point module.

The eyebrow key point module is configured to obtain at least one eyebrow key point based on the face key points.

The first region determining module 72 is configured to determine the first region by taking the center of the mouth as the center point of the first region, and taking a vertical distance from the center of the mouth to an eyebrow as a side length or a radius, wherein the eyebrow is determined based on the eyebrow key point.

The working process, the setting mode, and the corresponding technical effects of any embodiment of the action recognition apparatus according to the embodiments of the present disclosure may be referred to the specific description of the above corresponding method embodiments of the present disclosure, which will not be described herein again.

According to another aspect of the embodiments of the present disclosure, an electronic device is provided, which includes a processor. The processor includes the action recognition apparatus according to any of the above embodiments.

According to another aspect of the embodiments of the present disclosure, an electronic device is provided, including: a memory configured to store executable instructions; and

a processor for communicating with the memory to execute executable instructions to complete operations in the action recognition method according to any of the above embodiments.

According to another aspect of the embodiments of the present disclosure, a non-transitory computer readable storage medium is provided, configured to store computer readable instructions, wherein the instructions are executed to perform the operations in the action recognition method according to any of the above embodiments.

According to another aspect of the embodiments of the present disclosure, a computer program product is provided, including computer readable codes, wherein the computer readable codes are running on a device to cause a processor in the device to execute instructions for implementing the action recognition method according to any of the above embodiments.

The embodiment of the present disclosure further provides an electronic device, for example, may be a mobile terminal, a personal computer (PC), a tablet computer, a server, etc. Referring now to FIG. 8, which shows a schematic structural diagram of an electronic device 800 suitable for implementing a terminal device or a server according to an embodiment of the present disclosure, as shown in FIG. 8. The electronic device 800 includes one or more processors, a communication unit, and the like. The one or more processors may be, for example, one or more central processing units (CPUs) 801, and/or one or more image processors (acceleration units) 813, etc. The processor may perform various appropriate actions and processes according to executable instructions stored in the read-only memory (ROM) 802 or executable instructions loaded from the storage section 808 into the random access memory (RAM) 803. The communication unit 812 may include, but is not limited to, a network card, and the network card may include, but is not limited to, an IB (Infiniband) network card.

The processor may communicate with the read-only memory 802 and/or the random access memory 803 to execute executable instructions, connect with the communication unit 812 via the bus 804, and communicate with other target devices via the communication unit 812, thereby completing operations corresponding to any method according to the embodiments of the present disclosure, for example, obtaining a plurality of mouth key points of a face based on a face image; determining an image in a first region based on the plurality of mouth key points, the image in the first region involving at least part of the plurality of mouth key points and an object interacting with mouth; and determining whether a person corresponding to the face image is smoking based on the image in the first region.

The RAM 803 may also store various programs and data required for device operation. The CPU 801, the ROM 802, and the RAM 803 are connected to each other via a bus 804. In the case where the RAM 803 is present, the ROM 802 is an optional module. The RAM 803 stores an executable instruction, or writes an executable instruction into the ROM 802 at runtime, and the executable instruction causes the central processing unit 801 to execute an operation corresponding to the foregoing communication method. The input/output (I/O) interface 805 is also connected to the bus 804. The communication unit 812 may be integrally arranged, or may be arranged to have a plurality of sub-modules (for example, a plurality of IB network cards) and be connected to a bus link.

The following components are connected to the I/O interface 805: an input section 806 including a keyboard, a mouse, etc. An output section 807 such as a cathode ray tube (CRT), a liquid crystal display (LCD), and the like, and a speaker. a storage section 808 including a hard disk or the like, and a communication section 809 including a network interface card such as a LAN card, a modem or the like. The communication section 809 performs communication processing via a network such as the Internet. Driver 810 is also connected to I/O interface 805 as needed. A detachable medium 811, such as a magnetic disk, an optical disk, a magneto-optical disk, a semiconductor memory, or the like, is mounted on the driver 810 as needed, so that a computer program read out therefrom is mounted in the storage section 808 as needed.

The architecture shown in FIG. 8 is merely an optional implementation, and during specific practice, the number and type of the components shown in FIG. 8 may be selected, deleted, added or replaced according to actual needs. Implementations such as separation setting or integration setting may also be adopted on different functional component arrangements, for example, the acceleration unit 813 and the CPU 801 may be separately arranged or the acceleration unit 813 may be integrated on the CPU 801, the communication unit may be separately arranged, or may be integrated on the CPU 801 or the acceleration unit 813, etc. These alternative embodiments all belong to the scope of protection disclosed herein.

In particular, according to embodiments of the present disclosure, the processes described above with reference to the flowcharts may be implemented as computer software programs. For example, an embodiment of the present disclosure comprises a computer program product comprising a computer program tangibly contained on a machine readable medium, the computer program comprising program codes for executing the method shown in the flowchart, and the program codes may comprise instructions corresponding to the step of executing the method provided in the embodiment of the present disclosure, for example, obtaining a mouth key point of a face based on a face image; determining an image in a first region based on a mouth key point, the image in the first region including at least part of a mouth key point and an image of an object interacting with mouth; and determining whether a person corresponding to the face image is smoking based on the image in the first region. In such embodiments, the computer program may be downloaded and installed from the network through the communication section 809 and/or installed from the removable medium 811. When the computer program is executed by the central processing unit (CPU) 801, the operation of the described function defined in the method of the present disclosure is performed.

Different examples in the present disclosure are described in a progressive manner. Each example focuses on the differences from other examples with those same or similar parts among the examples to be referred to each other. Particularly, since the data processing device examples are basically similar to the method examples, the device examples are briefly described with relevant parts referred to the descriptions of the method examples.

The methods and apparatuses of the present disclosure may be implemented in a number of ways. For example, the methods and apparatuses of the present disclosure may be implemented by software, hardware, firmware, or any combination of software, hardware, firmware. The above-mentioned order of the steps for the method is merely for illustration, and the steps of the method of the present disclosure are not limited to the order specifically described above, unless specifically stated otherwise. Furthermore, in some embodiments, the present disclosure may also be embodied as programs recorded in a recording medium, including machine readable instructions for implementing the method according to the present disclosure. Accordingly, the present disclosure also covers a recording medium storing a program for executing the method according to the present disclosure.

The description of the present disclosure is given for purposes of example and description and is not missing or limiting the present disclosure to the disclosed forms. Many modifications and variations will be apparent to those skilled in the art. The embodiments are chosen and described in order to better illustrate the principles and practical applications of the present disclosure, and to enable those skilled in the art to understand the present disclosure in order to design various embodiments with various modifications suitable for specific purpose.

1. An action recognition method, comprising:
obtaining mouth key points of a face based on a face image;
determining, based on the mouth key points, an image in a first region involving at least part of the mouth key points and comprising an image of an object interacting with a mouth; and
determining whether a person corresponding to the face image is smoking based on the image in the first region.

2. The method according to claim 1, wherein
before determining whether the person corresponding to the face image is smoking based on the image in the first region, the method further comprises:
obtaining at least two first key points of the object interacting with the mouth based on the image in the first region; and
screening the image in the first region based on the at least two first key points, to select out the image in the first region in which the object interacting with the mouth and having a length greater than or equal to a preset value is involved, and
determining whether the person corresponding to the face image is smoking based on the image in the first region comprises:
in response to that the image in the first region passes the screening, determining whether the person corresponding to the face image is smoking based on the image in the first region.

3. The method according to claim 2, wherein screening the image in the first region based on the at least two first key points comprises:
determining key point coordinates corresponding to the at least two first key points in the image in the first region; and
screening the image in the first region based on the key point coordinates corresponding to the at least two first key points.

4. The method according to claim 3, wherein screening the image in the first region based on the key point coordinates corresponding to the at least two first key points comprises:
determining, based on the key point coordinates corresponding to the at least two first key points, a length of the object interacting with the mouth which is involved in the image in the first region;
in response to that the length of the object interacting the mouth is greater than or equal to the preset value, determining that the image in the first region passes the screening; and
in response to that the length of the object interacting with the mouth is less than the preset value, determining that the image in the first region fails to pass the screening, and determining that the image in the first region does not involve a cigarette.

5. The method according to claim 3, wherein before determining the key point coordinates corresponding to the at least two first key points in the image in the first region, the method further comprises:
assigning a serial number to each of the at least two first key points to distinguish the at least two first key points.

6. The method according to claim 3, wherein determining the key point coordinates corresponding to the at least two first key points in the image in the first region comprises:
determining, by a first neural network, the key point coordinates corresponding to the at least two first key points in the image in the first region, wherein the first neural network is trained with a first sample image.

7. The method according to claim 6, wherein the first sample image comprises labelled key point coordinates, and training the first neural network comprises:
inputting the first sample image into the first neural network to obtain predicted key point coordinates corresponding to the at least two first key points;
determining a first network loss based on the predicted key point coordinates and the labelled key point coordinates; and
adjusting a parameter of the first neural network based on the first network loss.

8. The method according to claim 2, wherein obtaining the at least two first key points of the object interacting with the mouth based on the image in the first region comprises:
performing a key point recognition for the object interacting with the mouth on the image in the first region to obtain at least two central axis key points on a central axis of the object interacting with the mouth.

9. The method according to claim 2, wherein obtaining the at least two first key points of the object interacting with the mouth based on the image in the first region comprises:
performing a key point recognition for the object interacting with the mouth on the image in the first region to obtain at least two side key points on each of two sides of the object interacting with the mouth.

10. The method according to claim 2, wherein obtaining the at least two first key points of the object interacting with the mouth based on the image in the first region comprises:
performing a key point recognition for the object interacting with the mouth on the image in the first region to obtain at least two central axis key points on a central axis of the object interacting with mouth and at least two side key points on each of two sides of the object interacting with the mouth.

11. The method according to claim 1, wherein
before determining whether the person corresponding to the face image is smoking based on the image in the first region, the method further comprises:
obtaining at least two second key points of the object interacting with the mouth based on the image in the first region;
aligning, based on the at least two second key points, the object interacting with the mouth in a way that the object interacting with the mouth is oriented to a preset direction; and
obtaining an image in a second region involving the object interacting with the mouth and oriented to the preset direction, wherein the image in the second region involves at least part of the mouth key points and comprises an image of the object interacting with the mouth; and
determining whether the person corresponding to the face image is smoking based on the image in the first region comprises:
determining whether the person corresponding to the face image is smoking based on the image in the second region.

12. The method according to claim 1, wherein determining whether the person corresponding to the face image is smoking based on the image in the first region comprises:
determining, by a second neural network, whether the person corresponding to the face image is smoking based on the image in the first region, wherein the second neural network is trained with a second sample image.

13. The method according to claim 12, wherein the second sample image is associated with a label of whether the person corresponding to the second sample image is smoking, and training the second neural network comprises:
inputting the second sample image into the second neural network to obtain a prediction of whether a person corresponding to the second sample image is smoking;
obtaining a second network loss based on the prediction and the label; and
adjusting a parameter of the second neural network based on the second network loss.

14. The method according to claim 1, wherein obtaining the mouth key points of the face based on the face image comprises:
performing a face key point extraction on the face image to obtain face key points in the face image; and
obtaining the mouth key points based on the face key points.

15. The method according to claim 14, wherein determining the image in the first region based on the mouth key points comprises:
determining a center of the mouth involved in the face image based on the mouth key points;
determining the first region by taking the center of the mouth as a center point of the first region and taking a preset length as a side length or a radius.

16. The method according to claim 15, wherein
before determining the image in the first region based on the mouth key points, the method further comprises:
obtaining at least one eyebrow key point based on the face key points; and
determining the first region by taking the center of the mouth as the center point of the first region and taking the preset length as the side length or the radius comprises:
determining the first region by taking the center of the mouth as the center point of the first region, and taking a vertical distance from the center of the mouth to a center of an eyebrow as the side length or the radius, wherein the center of the eyebrow is determined based on the at least one eyebrow key point.

17. An electronic device, comprising:
a memory configured to store executable instructions; and
a processor configured to communicate with the memory to execute the executable instructions to perform operations comprising:
obtaining mouth key points of a face based on a face image;
determining, based on the mouth key points, an image in a first region involving at least part of the mouth key points and comprising an image of an object interacting with a mouth; and
determining whether a person corresponding to the face image is smoking based on the image in the first region.

18. A non-transitory computer readable storage medium, configured to store computer readable instructions, wherein the instructions are executed by a processor to perform operations comprising:
obtaining mouth key points of a face based on a face image;
determining, based on the mouth key points, an image in a first region involving at least part of the mouth key points and comprising an image of an object interacting with a mouth; and
determining whether a person corresponding to the face image is smoking based on the image in the first region.
